(19) United States
(12) Patent Application Publication
(10) Pub. No.: US 2009/0266469 A1
(43) Pub. Date: Oct. 29, 2009

(54) PROCESS AND DEVICE FOR AUTOMATICALLY DETERMINING THE BEGINNING OF A WELDING PROCESS FOR MAKING TUBULAR LABELS

(75) Inventors: Vanni Zacche, Mantova (IT); Daniele Marastoni, Mantova (IT); Pringpuangkeo Phuchakr, Mantova (IT)

Correspondence Address: Pearne & Gordon LLP, 1801 East 9th Street, Suite 1200, Cleveland, OH, 44114-3108, US

(73) Assignee: SIDEL S.P.A., Parma (IT)

(21) Appl. No.: 11/722,099

(22) PCT Filed: Dec. 15, 2005
(86) PCT No.: PCT/EP2005/013512

§ 371 Date: Mar. 1, 2009

(30) Foreign Application Priority Data
Dec. 20, 2004 (IT) PR2004A000094

(51) Int. Cl. B32B 37/00

(52) U.S. Cl. 156/64; 156/350

(57) ABSTRACT

The invention pertains to the field of apparatuses for automatically determining the beginning of a welding process which makes tubular labels of plastic film. The device comprises a welding element, such as a sonotrode (2) for performing an ultrasonic welding, which is mounted to turrets of a labelling machine. The device is formed of two parts, one movable and one stationary fixed to the turret and comprises sliding elements engaged in a respective guide (4) which allow the sonotrode (2) to slide when it is stopped by the opposite resistance of the object to be welded. Meanwhile, since the distance between said stationary and movable elements diminishes, a spring (11) is compressed and a sensor (8) triggers the translation and welding step. The spring (11) move the sonotrode (2) back to the initial position when the device (1) is moved away from the welded label. The process provides that the welding vertical translating step starts when the sonotrode contacts the labels to be welded.

The present invention relates to a method and device for automatically determining the beginning of a welding process that makes tubular labels of plastic film in labelling machines.

Particularly, reference is made to ultrasonic welding apparatuses which are mounted to labelling machines and capable to apply tubular labels on cylindrical bodies or generally on solids of revolution, the labelling machines can be of the linear or carousel type.

Turrets are mounted to said labelling machines, which compel a sonotrode (that is a welding element) to move in a way to continuously contact the area of the label where its edges overlap.

Advantageously, the device of the present invention can be mounted to a type of labelling machine which was the object of the Italian patent application No. PR02A000018 filed by the same applicant of the present invention.

Briefly, in the above mentioned application, it is disclosed an ultrasonic welding device which is located on a turret, said turret approaches a surface to be labelled along a predetermined axis and after, once the device contacts the area of the overlapped edges, it starts a welding operation running on the length of the area of the overlapped edges.

After the completion of the welding operation, the ultrasonic welding apparatus moves away, returning to the starting position.

The device of the present invention is mounted to a turret of the above mentioned machine and it is implemented in such a way to determine the translation and welding operation independently from the position of the edge to be welded, in other words, from the diameter of the container where the label is located.

Reference is made to an ultrasonic welding system even though the inventive device can be mounted to every kind of devices which are based on the same operating principles to determine the instant in which the process in object must be started.

A welding process is defined by specific physical parameters, such as pressure, frequency, electric current, the rate for making the welding bead; in other words in order to provide a smooth and constant welding it is necessary that these parameters should be maintained as much as possible constant.

In order to obtain a constant and effective welding in every spot along the area where the label edges overlap, it is essential to start the process simultaneously with the translation of the welding element and when it comes in contact with the label to keep constant the above mentioned parameters.

If the above cited conditions are not satisfied, some drawbacks can occur, such as:
welding beads incomplete with respect to the length of the overlapping area,
weak welding beads which easily detach after the welding step.
swelling of the welded area until the labels become perforated.

Consequences of the above said disadvantages are: not optimal welding quality and increasing number of labels and/or containers discarded.

Nowadays the technique uses mechanical means such as stops to locate on a pneumatic spring that is attached to a welding assembly, which starts the welding when it abuts the stop.

After, the mechanism is positioned again by means, such as lever mechanisms or actuators, allowing the retriggering of the control system.

With the prior art, it is necessary to move the reference stops depending on the diameter of the bottle on which the label must be applied, moreover mechanical events such as the wear of the sliding components and the increasing play between the same, make necessary a continuous and frequent maintenance to restore the proper operation of the above cited mechanical means because the plays are not automatically compensated by the same device.

To these drawbacks should be added that a manual adjustment determines downtimes of the machine, and even though each of these downtimes is very short, at the end of a day they all amount to an unacceptable value, if it is taken into consideration the high number of containers on which the same machine applies and welds the label.

In addition to that, the manual adjustment determine a higher number of rejections due to the initial adjustment step and wrong judgments in positioning the adjustment means.

The object of the present invention is to solve the above cited drawbacks by a device which determines, independently of the container diameter, the instant wherein the process for welding the label must start, moreover said device is capable to return to its initial position despite the occurrence of possible plays due to the wear of the mechanical couplings.

Consequently, whichever the contact diameter and stroke of the translating assembly may be, the presence of the intermediate guide insure the exact starting when the welding element reaches the label, keeping constant the welding parameters.

The advantages of the present invention are schematically the following:
The welding rate is positively kept constant from the initial to the final instant.
Uniform welding for long periods of operation of the welding machine.
Uniform welding irrespectively the format diameter on which the label is welded and without an additional initial adjustment.
the number of rejections is cut to zero once the machine has been initially set up for determining the correct welding parameters.
The adjustment is not necessary even though the sonotrode and tools wear.

The above objects and advantages are fulfilled by the device for automatically determining the beginning of a welding process of the present invention, that it is characterized by the attached claims.

These and other characteristics will be better understood by the following description of some embodiments illustrated as illustrative non limiting examples in the following drawings, wherein:

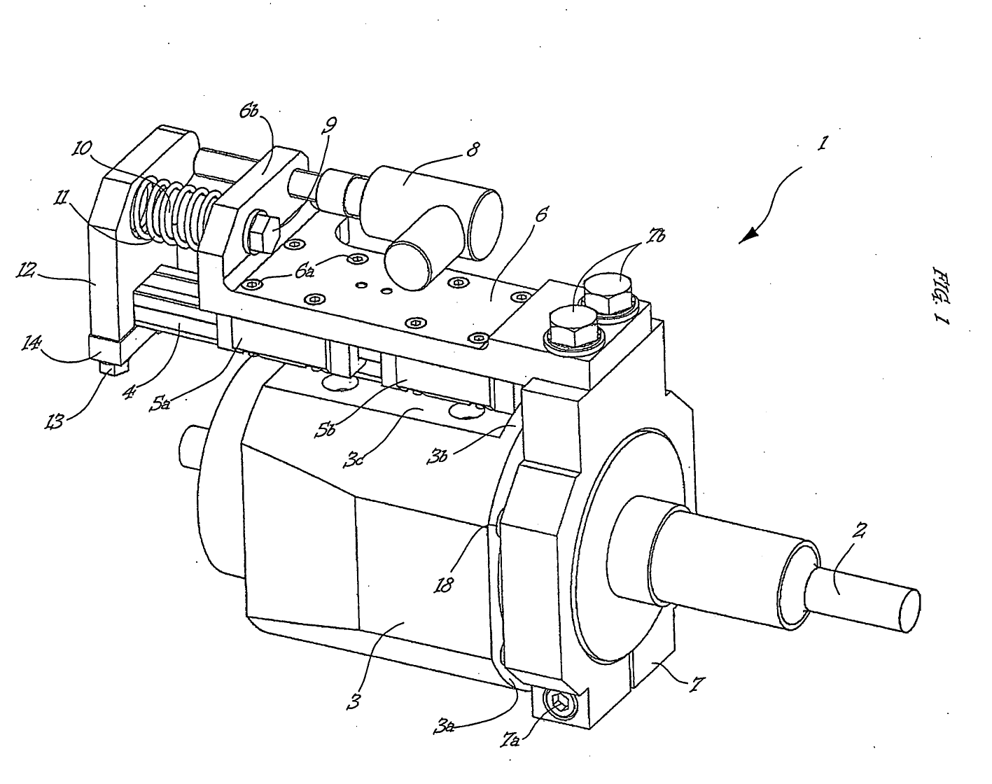

FIG. 1 is a general perspective view of an automatic device for the beginning of the welding according to the present invention,

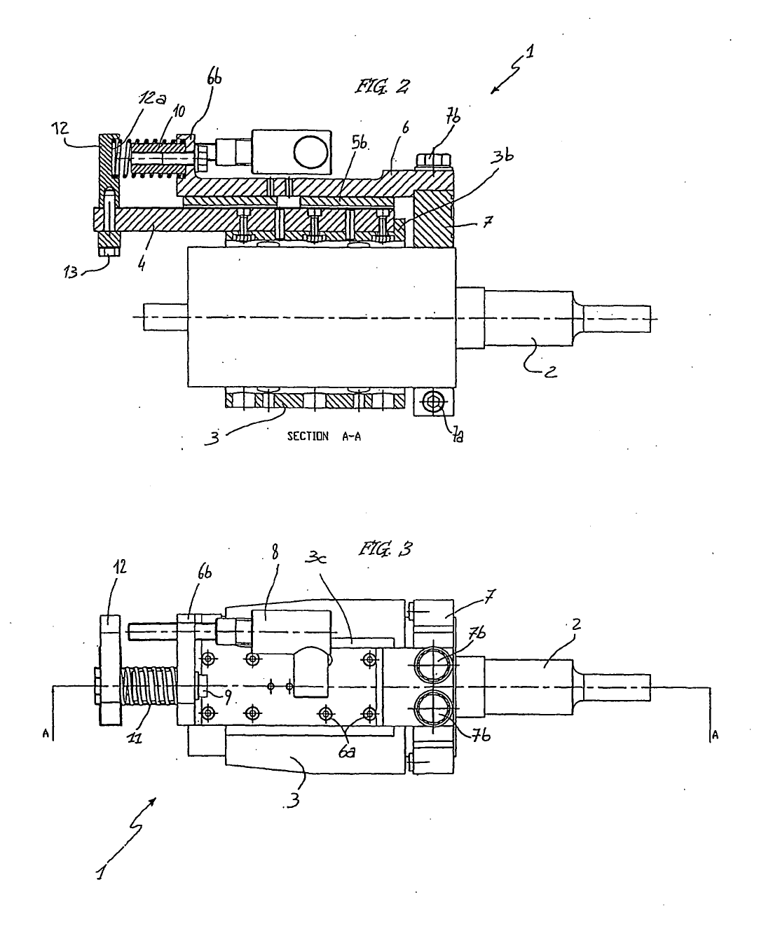

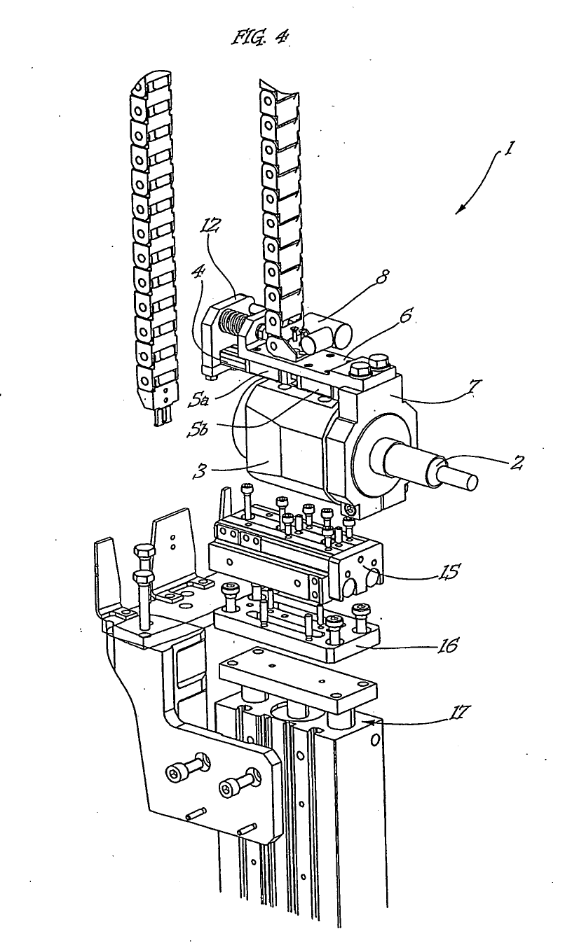

FIG. 2 show section A-A of FIG. 3,

FIG. 3 is a top view of the device of FIG. 1,

FIG. 4 schematically shows, in part, the assembly of a possible embodiment of the present invention to a labelling machine which uses the apparatus for ultrasonically welding tubular labels.

With reference to FIG. 1, 1 generally shows a device for automatically determining a welding step, specifically an ultrasonic welding.

The device, as shown in FIG. 4, is attached to one or more turrets of a labelling machine that manufactures labels made of a thermo shrinkable film.

Every turret comprises a vertical actuator 17 to which a registering plate 16 is fixed that in turn is fixed to a horizontal actuator 15 which allows the device 1 mounted on it, to approach the label and consequently the winding drum (not illustrated) on which the label is ready to be welded.

The vertical actuator 17 is designed to provide the travel along the area of the overlapping label edges.

The portion of device 1 that is fixed to the turret (particularly to actuator 15) shown by reference 3, is a cylindrical support which receives the welding element, in this case a sonotrode 2.

The sonotrode 2 is located coaxially and concentrically in the cylindrical support 3, which is fixed to a mounting 7 by means of a tightening screw 7a.

Mounting 7 is in turn connected, by components to be described, to sliding means engaged in a straight guide 4, which in turn is connected to the cylindrical support 3.

As a consequence, the translation of the sliding means in the guide 4 causes a corresponding translation of mounting 7 and consequently of the sonotrode 2.

Said sliding means in the illustrated example are embodied by sliding shoes 5a and 5b.

The upper surface of the cylindrical support 3 is almost completely flat in order to have a bearing surface 3c to which the guide 4 is connected.

The upper surface of the cylindrical support 3 is machined only on one side of the bearing surface 3c, in order to form a ledge 3b against which the sliding shoe 5b is biased by a resilient element 11.

Specifically, sliding shoes 5a and 5b are fixed by known fasteners 6a to a disk 6 to which is also fixed the mounting 7 by screws 7b, in the end part of disk 6.

From the above description and FIGS. 2 and 3, it is understood that sonotrode 2 is allowed to translate along its own axis because it is connected to shoes 5a and 5b which freely slide in guide 4.

The sliding motion is stopped when mounting 7 abuts the cylindrical support 3.

The device 1 comprises also other components essential for the operation of the object: a spring 11 and a sensor 8, inserted in the device 1 and adapted to reset the device in the initial position (spring 11) and to start the translation and welding step (sensor 8).

The end part of disk 6, opposite to the part on which the mounting 7 is attached, is curved and terminates with a strap 6b perpendicular to disk 6, having two holes in which a sensor 8 and a screw 9 are engaged, the latter holds a pin 10.

At a distance from strap 6b there is an end plate 12 fixed to the guide 4 by screws 13 and a small fixing bar 14.

Between the end plate 12 and the strap 6b there is a spring 11 partially inserted in pin 10 and located in a seat 12a in order to avoid its displacement during its compression.

In other words, the device can be considered as formed by two assembly of elements reciprocally moving:
Stationary elements fixed to the welding turret, in the example shown, they are the cylindrical support 3, guide 4 and end plate 12;
Movable elements: which can slide with respect to said stationary elements, such as the sonotrode 2, mounting 7, disk 6 and shoes 5a and 5b.

In the example shown, sensor 8 belongs to the movable assembly of device 1.

In the following there will be described the process for automatically determining the beginning of the welding operation of a labelling machine using device 1.

The actuator 15 moves the device 1 towards a winding drum carrying the label to be welded: during this step stationary and movable elements translate of the same amount.

Once the sonotrode 2 abuts said winding drum, it is prevented from further moving by actuator 15, so that by means of shoes 5a and 5b sliding in guide 4, the assembly of movable elements (sonotrode 2, mounting 7, disk 6 and sensor 8) can remain in the shown position, leaving the assembly formed by the stationary components (cylindrical support 3, guide 4 and end plate 12) free of sliding, so that it keeps moving in said direction.

After the sonotrode 2 is in contact with the container, the distance between the end plate 12 and the strap 6b (that is between stationary elements and movable elements) decreases while spring 11 is being compressed.

As said distance comes smaller, mounting 7 approaches surface 3a of the cylindrical support 3 and sensor 8 is activated (due to the presence of the end terminal 12) starting the translation step of the actuator 17, the sonotrode 2 is certainly against the label.

The strike between the surface 3a and the cylindrical support can be cushioned by inserting one or more damping means 18.

At the end of the welding step, actuator 15 is retracted and the elements of device 1 precisely return to the initial position because spring 11, compressed when it approaches, pushes the disk 6 until the shoe 5b abuts said ledge 3b machined in the cylindrical support 3.

After the operation of the spring 11, sensor 8 turns off and returns to its standby position waiting a new process.

In the shown example of an embodiment of a device for automatically determining the welding step, reference has been made to elements defined as stationary and movable elements: it is understood that the cited definition of each element is only an illustrative example, and without falling out of the scope of the present invention, some of the cited members indicated as stationary elements could be part of the movable elements or some of the cited members indicated as movable elements could be part of the stationary elements; particularly, the “function interchangeability” could be had for the sliding means 5a, 5b, with the guide 4, or for the sensor 8 with the end plate 12.

In the description has been made reference to a labelling machine using an ultrasonic welding apparatus for tubular labels; it is understood, without falling out of the scope of the present invention, that said example can be extended to any welding apparatus using instead of the sonotrode 2 another kind of welding member, and in the same way the extension can also encompasses ultrasonic and not ultrasonic welding apparatuses, which are connected and used on different kind of machines.

In the description, sensor 8 has been mentioned in a generic way, preferably it is a proximity or position sensor.

The method for automatically determining the beginning of the welding process comprises a first step of moving the sonotrode near the label to be welded till the sonotrode contacts the label to be welded.

This contact triggers the second and real welding step along a vertical travel.

It is therefore the contact of the sonotrode with the label that determines the starting of the second step.

The vertical translation ends when the welding is finished, and afterward begins the third step, when the sonotrode draws apart from the welded label and returns to the starting position.

1. Method for automatically determining the beginning of a welding process for making tubular labels of plastic film of the type comprising a welding element, such a sonotrode for making an ultrasonic welding attached to a welding turret of a labelling machine which performs the process in three steps, a first step of approaching to a label to be welded, a second step of welding as a result of the vertical translation of the welding element and a third step of moving away from the welded label and returning to the initial position, characterized by the fact that the second step of vertical welding translation starts when the sonotrode contacts the label to be welded, first step of the process, in that the welding starting signal is generated by a sensor actuated by the reciprocal sliding of a movable structure carrying the sonotrode and a vertically translating support structure.

2. Device for automatically determining the beginning of a welding process which makes tubular labels of a plastic film, of the type comprising a welding element, such as a sonotrode (2) for carrying out an ultrasonic welding, mounted to one or more welding turrets of a labelling machine which performs the process in three steps: a first step of approaching the sonotrode to an object to be welded, a second step of vertically translating and welding along the overlapped label edges and a third step of moving away from the welded label, characterized by the fact that it comprises:
a. stationary elements integral with the welding turret, such as a cylindrical support (3) in which the sonotrode slides (2), movable elements slidable with respect to the stationary elements by sliding means engaged in at least one guide (4); after said sliding motion and reduction of the distance between stationary and movable elements, a sensor (8) turns on to stop the approaching step and consequently the following translating and welding step starts;
b. elastic means (11) are located between the stationary and movable elements and they are compressed by the advancement of the welding turret after the sonotrode (2) abuts the label to be welded.

3. Device according to claim 2, characterized by the fact that the elastic means (11) pushing the movable elements bring back the device (1) to the initial position when the device is moved away from the welded object.

4. Device according to claim 2, characterized by the fact that the sliding means can be part of the movable elements or stationary elements depending on how the guide (4) is fixed.

5. Device according to claim 2, characterized by the fact that the sliding means can be two or more shoes (5a, 5b), two or more bushes, two or more bearings engaging the guide (4).

6. Device according to claim 2, characterized by the fact that it comprises a stopping element or an abutment surface (3c), being part of the stationary elements, for stopping the movable elements during their return stroke, urged by the elastic means (11).

7. Device according to claim 2, characterized by the fact that the elastic means can be an air or mechanical spring (11).

8. Device according to claim 23, characterized by the fact that the sensor (8) can be part of the movable elements or stationary elements.

9. Device according to claim 4, characterized by the fact that the sliding means can be two or more shoes (5a, 5b), two or more bushes, two or more bearings engaging the guide (4).

10. Device according to claim 3, characterized by the fact that it comprises a stopping element or an abutment surface (3c), being part of the stationary elements, for stopping the movable elements during their return stroke, urged by the elastic means (11).

11. Device according to claim 3, characterized by the fact that the elastic means can be an air or mechanical spring (11).

12. Device according to claim 3, characterized by the fact that the sensor (8) can be part of the movable elements or stationary elements.
